(19) United States
(12) Patent Application Publication
(10) Pub. No.: US 2023/0155752 A1
(43) Pub. Date: May 18, 2023

(54) User Equipment Assisted Carrier Aggregation

(71) Applicant: Apple Inc., Cupertino, CA (US)

(72) Inventors: Wei ZHANG, Santa Clara, CA (US); Sriram SUBRAMANIAN, San Jose, CA (US); Sandeep K SUNKESALA, San Jose, CA (US); Vishwanth KAMALA GOVINDARAJU, Mountain View, CA (US); Tarakkumar G DHANANI, San Jose, CA (US); Mandhukar K SHANBHAG, Santa Clara, CA (US); Sanjeevi BALASUBRAMANIAN, San Jose, CA (US); Alosious Pradeep PRABHAKAR, Singapore (SG); Shiva Krishna NARRA, San Jose, CA (US); Vijay VENKATARAMAN, San Jose, CA (US); Vijay GADDE, San Jose, CA (US); Sharad GARG, Cupertino, CA (US); Pengkai ZHAO, Cupertino, CA (US); Yi SU, Saratoga, CA (US); Jia TANG, San Jose, CA (US); Johnson O SEBENI, Fremont, CA (US); Haitong SUN, Cupertino, CA (US); Wei ZENG, Saratoga, CA (US); Yuchul KIM, San Jose, CA (US); Hong HE, San Jose, CA (US); Dawei ZHANG, Saratoga, CA (US); Chunhai YAO, Beijing (CN); Yushu ZHANG, Beijing (CN)

(21) Appl. No.: 17/995,458

(22) PCT Filed: Apr. 8, 2020
(86) PCT No.: PCT/CN2020/083824

§ 371 Date: Oct. 4, 2022

(51) Int. Cl. H04L 5/00; H04W 24/08

(52) U.S. Cl. CPC H04L 5/001; H04W 24/08; H04L 5/0098; H04L 5/0053

(57) ABSTRACT

Embodiments include a user equipment (UE) and methods performed by the UE. The methods include receiving a measurement configuration request from a network, in response to the measurement configuration request, measuring a quality of one or more uplink (UL) carrier aggregation (CA) combinations, wherein each UL CA combination comprises a plurality of component carriers, generating a message that includes the quality of the one or more UL CA combinations and transmitting the message to the network. Further embodiments include the above operations being performed as a set of instructions executed by a processor or an integrated circuit that includes circuitry to perform the operations.

### BACKGROUND

A user equipment (UE) may establish a connection to at least one of a plurality of different networks or types of networks. When establishing the network connection such as, for example, a connection to a 5G new radio (NR) network, the UE may provide capability information to the network that indicates the radio access capabilities of the UE. The capability information may enable the network to provide the UE with relevant services. For example, the UE may advertise a plurality of band combinations that may be used for dual-connectivity (DC) and/or carrier aggregation (CA). Subsequently, to provide the UE with DC and/or CA, the network may configure the UE with a plurality of component carriers (CCs) to facilitate communication between the network and the UE over one of the advertised band combinations.

While connected to the network(s), the UE may utilize further network capabilities. For example, the UE may utilize a carrier aggregation (CA) functionality in which a primary component carrier (PCC) and at least one secondary component carrier (SCC) are used to communicate data over the various network bands. Typically, the UE advertises the combinations of PCC and SCCs that are supported by the UE. Subsequently, the network determines the CCs included in the CA such as, for example, the uplink (UL) CA. However, the network does so without any feedback from the UE. As such, the UL CA combinations selected by the network may include CCs that result in inferior power and/or throughout performance and, thus, lower network efficiency.

### SUMMARY

In some exemplary embodiments, a method is performed by a user equipment. The method includes receiving a measurement configuration request from a network, in response to the measurement configuration request, measuring a quality of one or more uplink (UL) carrier aggregation (CA) combinations, wherein each UL CA combination comprises a plurality of component carriers, generating a message that includes the quality of the one or more UL CA combinations and transmitting the message to the network.

Further exemplary embodiments include a method performed by a user equipment (UE) with uplink (UL) carrier aggregation (CA) activated, the UL CA comprising a UL CA combination comprising primary component carrier (PCC) and a secondary component carrier (SCC). The method includes determining that the UL CA should be deactivated and transmitting a quality report to a network comprising quality measurements for only the PCC.

Still further exemplary embodiments include a method performed at a network component. The method includes instructing a UE to send transmit first sounding reference signals (SRS) on component carriers (CC) of a first UL CA combination, receiving the first SRSs on the CCs of the first UL CA combination and determining quality characteristics of the first UL CA combination based on the first SRSs.

### BRIEF DESCRIPTION OF THE DRAWINGS

FIG. 1 shows an exemplary network arrangement according to various exemplary embodiments.

FIG. 2 shows an exemplary UE according to various exemplary embodiments.

FIG. 3 shows a signaling diagram that relates to configuring the UE with a network connection that includes UE feedback according to various exemplary embodiments.

FIG. 4 shows a method of configuring the UE with a network connection that includes UE feedback according to various exemplary embodiments.

FIG. 5 shows a method of deactivating an uplink carrier aggregation by the UE according to various exemplary embodiments.

FIG. 6 shows a signaling diagram that relates to SRS UL CA activation according to various exemplary embodiments.

### DETAILED DESCRIPTION

The exemplary embodiments may be further understood with reference to the following description and the related appended drawings, wherein like elements are provided with the same reference numerals. The exemplary embodiments relate to a device, system and method for communicating feedback related to a user equipment (UE) uplink (UL) carrier aggregation (CA) to a network (NW) to which the UE is connected.

The exemplary embodiments are described with regard to a UE. However, the use of a UE is merely for illustrative purposes. The exemplary embodiments may be utilized with any electronic component that may establish a connection with a network and is configured with the hardware, software, and/or firmware to exchange information and data with the network. Therefore, the UE as described herein is used to represent any electronic component.

The exemplary embodiments are also described with regard to a network (NW) that includes 5G new radio (NR) radio access technology (RAT). However, in some embodiments, the network may also include a Long-Term Evolution (LTE) RAT even though the following description will focus primarily on 5G NR RAT. In some embodiments, the network may support carrier aggregation (CA) and/or LTE-NR dual-connectivity (ENDC). Although the following description will focus primarily on CA, both CA and ENDC relate to the UE being configured with a plurality of component carriers (CCs). Each CC may represent a channel that facilitates communication between the UE and the network over a particular frequency band. A plurality of CCs may correspond to the same frequency band, each CC may correspond to a different band or a combination thereof. Further, each CC has a particular bandwidth, the more CCs the UE is configured with the more bandwidth that is available for communications with the network.

The UE may be configured to access 5G NR services when operating in non-standalone (NSA) mode for 5G or standalone (SA) mode for 5G. In NSA mode, the UE may establish a connection with both 5G NR RAT and LTE RAT (e.g., ENDC).

The following examples provide a general overview of a type of carrier aggregation (CA) activation/deactivation functionality. CA may include a primary component carrier (PCC) and at least one secondary component carrier (SCC) that correspond to the same RAT being used to facilitate communication with the network. The PCC may be used, in part, for control information such as scheduling requests, uplink grants, downlink grants, etc. CA functionality enables the PCC and at least one SCC to combine bandwidths to exchange data with the UE. Thus, with CA, the PCC may provide a first portion of a total bandwidth for data to be exchanged while the SCC may provide a second portion of the total bandwidth. The combination of a PCC and a single SCC may be characterized as a CC combination that includes two carriers. To further increase the total available bandwidth for data to be exchanged with the UE, additional SCCs may be incorporated.

Several issues may arise with the current method of providing UL CA to a UE without any UE preference feedback regarding UL CA combinations. For example, dynamic transmit antenna selection for different UL CCs may have conflicts and thus some CCs may end up with a less preferred transmission (Tx) antenna. Furthermore, some Tx CC combinations may lead to interference on the DL side due to intermodulation, especially in a non-standalone (NSA) scenario with LTE UL present at the same time. Still further, there could be other limitations on UE such as, for example, negative thermal impacts of some UL CA combinations, some bands being incapable of being transmitted on all Tx antennas, thus leading to less robustness. The UE may not be experiencing similar conditions on the UL as compared to the DL due to various factors such as, for example, specific absorption rate (SAR) limitations, inaccurate beam correspondence, etc. As such, without UE preference feedback, a UL CA combination can be activated that leads to inferior power/throughput performance and, therefore, lower NW efficiency.

According to a first exemplary embodiment, a manner of providing UE preference feedback to the NW regarding UL CA combinations is described. As will be described in further detail below, the UE may provide preference feedback regarding UL CA combinations to the NW periodically, based on the occurrence of a predetermined event, or based on a trigger. The NW can take this feedback into consideration when activating CCs for the UL CA.

According to a second exemplary embodiment, the NW may alternatively instruct the UE to send sounding reference signals (SRS) on CCs even before those CCs are added to the UL CA combination. Using this SRS approach, the NW may obtain a better understanding of the UL conditions directly. After the UE SRS transmission(s), the NW may activate CCs for a UL CA combination.

Additional issues may arise with respect to UL CA deactivation/deconfiguration by a UE. For example, if a UE unilaterally deactivates a UL CA because the UL CA is harmful to the UE due to undesirable thermal and/or power consumption effects and does so without notifying the NW, confusion on the NW side may result (i.e., because of the asymmetrical information on the NW side). Furthermore, with respect to power efficiency, a given UL CA may be less desirable when the UL data traffic rate is lower than a certain threshold determined by the UE (known to the UE, but not the NW).

According to a third exemplary embodiment, the UE may suggest to the NW that the UL CA be deactivated by sending a quality report in which only the PCC as the single CC for the UL CA combination to indicate the limitations of the UE. Alternatively, the UE may send a quality report to the NW in which thermal/power limitations of the UE are set to true for all UL CA combinations. Although it is up to the NW's discretion whether or not to honor the UE's request to deactivate/deconfigure the UL CA, the confusion on the NW side is eliminated if the UE later deactivates the UL CA unilaterally.

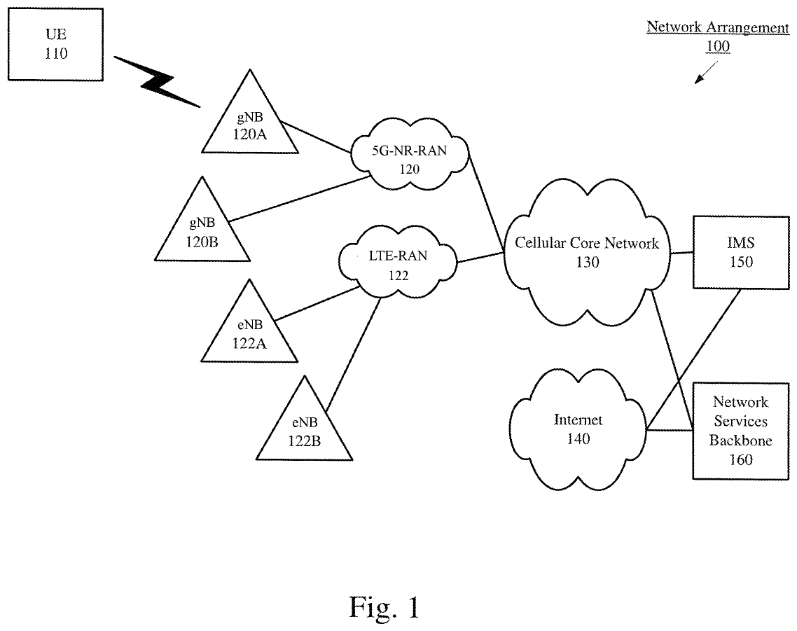

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the networks with which the UE 110 may wirelessly communicate are a 5G New Radio (NR) radio access network (5G NR-RAN) 120 and an LTE radio access network (LTE-RAN) 122. However, it should be understood that the UE 110 may also communicate with other types of networks (e.g. legacy cellular network, WLAN, etc.) and the UE 110 may also communicate with networks over a wired connection. With regard to the exemplary embodiments, the UE 110 may establish a connection with the 5G NR-RAN 120 and/or the LTE-RAN 122. Therefore, the UE 110 may have both a 5G NR chipset to communication with the 5G NR-RAN 120 and an LTE chipset to communicate with the LTE-RAN 122.

The 5G NR-RAN 120 and the LTE-RAN 122 may be portions of cellular networks that may be deployed by cellular providers (e.g., Verizon, AT&T, Sprint, T-Mobile, etc.). These networks 120 and 122 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

The use of a separate 5G NR-RAN 120 and an LTE-RAN 122 is merely provided for illustrative purposes. An actual network arrangement may include a radio access network that includes architecture that is capable of providing both 5G NR RAT and LTE RAT services. For example, a next-generations radio access network (NG-RAN) may include a next generation Node B (gNB) that provides 5G NR services and a next generation evolved Node B (ng-eNB) that provides LTE services. The NG-RAN may be connected to at least one of the evolved packet core (EPC) or the 5G core (5GC). Thus, in one exemplary configuration, the UE 110 may achieve ENDC by establishing a connection to at least one cell corresponding to the 5G NR-RAN 120 and at least one cell corresponding to the LTE-RAN 122. In another exemplary configuration, the UE 110 may achieve ENDC by establishing a connection to at least two cells corresponding to the NG-RAN or other type of similar RAN. Accordingly, the example of a separate 5G NR-RAN 120 and an LTE-RAN 122 is merely provided for illustrative purposes.

Returning to the exemplary network arrangement 100, the UE 110 may connect to the 5G NR-RAN 120 via at least one of the next generation Node B (gNB) 120A or the gNB 120B. The UE 110 may connect to the LTE-RAN 122 via at least one of the evolved Node B (eNB) 122A or eNB 122B. Those skilled in the art will understand that any association procedure may be performed for the UE 110 to connect to the 5G NR-RAN 120 or the LTE-RAN 122. For example, as discussed above, the 5G NR-RAN 120 may be associated with a particular cellular provider where the UE 110 and/or the user thereof has a contract and credential information (e.g., stored on a SIM card). Upon detecting the presence of the 5G NR-RAN 120, the UE 110 may transmit the corresponding credential information to associate with the 5G NR-RAN 120. More specifically, the UE 110 may associate with a specific cell (e.g., the gNB 120A of the 5g NR-RAN 120). Similarly, for access to LTE services, the UE 110 may associate with eNB 122A. However, as mentioned above, the use of the 5G NR-RAN 120 and the LTE-RAN 122 is for illustrative purposes and any appropriate type of RAN may be used.

In addition to the RANs 120 and 122, the network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. It may include the EPC and/or the 5GC. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

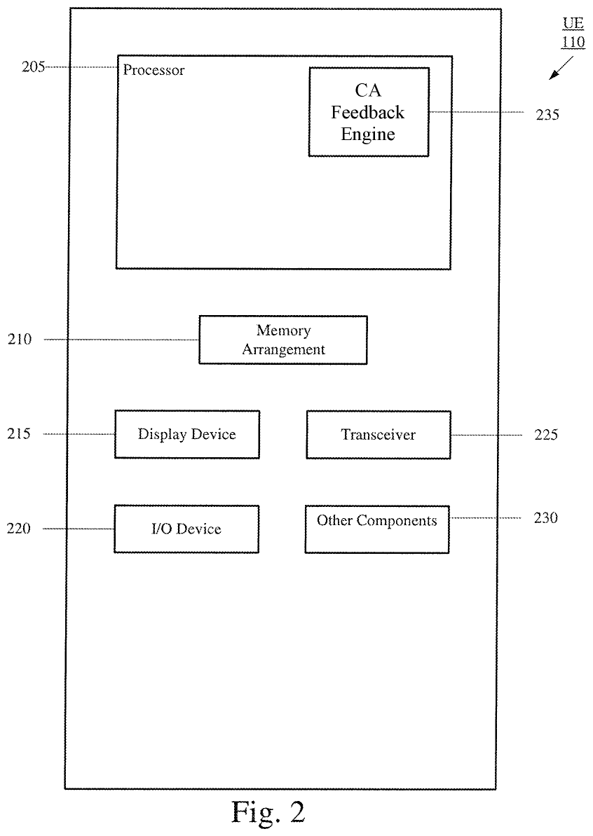

FIG. 2 shows an exemplary UE 110 according to various exemplary embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc.

The processor 205 may be configured to execute a plurality of engines for the UE 110. For example, the engines may include a CA feedback engine 235. The CA feedback engine 235 may receive a plurality of component carriers (CC) that the UE 110 identifies may be utilized for the network connection. Subsequently, the CA feedback engine 235 may prioritize particular CC combinations based on various factors. The CC combinations are then advertised based on their corresponding priority.

The above referenced engines each being an application (e.g., a program) executed by the processor 205 is only exemplary. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, the LTE-RAN 122 etc. Accordingly, the transceiver 225 may operate on a variety of different frequencies or channels (e.g., set of consecutive frequencies).

When connected to a network (e.g., 5G NR-RAN 120, LTE-RAN 122), the UE 110 may be configured to be in one of a plurality of different operating states. One operating state may be characterized as RRC idle state and another operating state may be characterized as RRC connected state. RRC refers to the radio resource control (RRC) protocols. Those skilled in the art will understand that when the UE 110 is in RRC connected state, the UE 110 and the network may be configured to exchange information and/or data. The exchange of information and/or data may allow the UE 110 to perform functionalities available via the network connection. Further, those skilled in the art will understand that when the UE 110 is connected to the network and in RRC idle state the UE 110 is generally not exchanging data with the network and radio resources are not being assigned to the UE 110 within the network. However, when the UE 110 is in RRC idle state, the UE 110 may monitor for information and/or data transmitted by the network.

As mentioned above, during operation, the UE 110 may be configured with CA, which relates to a plurality of CCs being used to facilitate communications between the network and the UE 110. To achieve CA, the UE 110 may initially provide the network with feedback regarding which CCs the UE prefers for CA (i.e., CA feedback information). The CA feedback information may include CC quality as well.

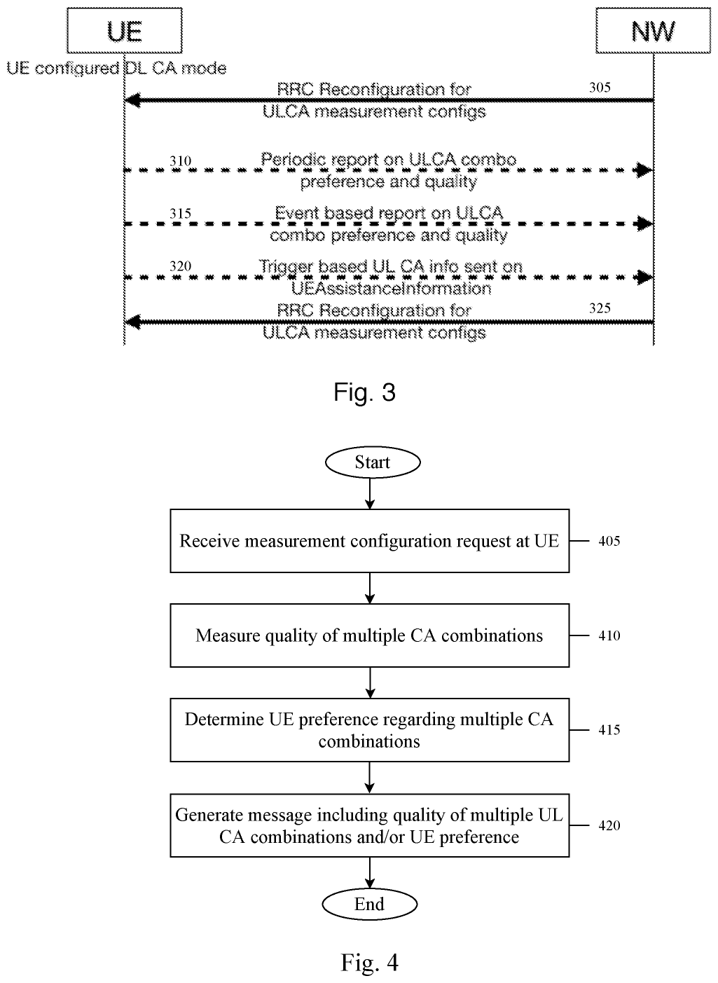

The signaling diagram of FIG. 3 shows a general example of how the network may provide the UE 110 with CA. However, the exemplary embodiments are not limited to the signaling diagram of FIG. 3. This signaling diagram is only intended to illustrate a general example of the context in which the UE 110 may advertise preferred UL CA combinations to the network. The exemplary embodiments apply to any scenario in which the UE 110 is triggered to advertise UL CA combinations to the network.

FIG. 3 shows a signaling diagram 300 that relates to configuring the UE 110 with CA according to various exemplary embodiments. The signaling diagram 300 will be described with regard to the UE 110 and the network arrangement 100. At 305, the 5G NR-RAN 120 sends a measurement configuration request to the UE regarding uplink carrier aggregation (UL CA). As a result, the UE 110 determines the quality of different CA combinations and UE 110 preferences regarding a specific one or more of the CA combinations. The quality of the different combinations may be based on any physical layer measurements that the UE 110 may perform on the downlink (DL) component carriers.

In some exemplary embodiments, the UE preference information may also be based on one or more quality measurements. For example, the UE preference information may be based on a quality measurement of a DL CC being above a predefined threshold. To provide a specific example, the Reference Signal Receive Power (RSRP) for a CC may be above a threshold. The threshold may be preconfigured in the UE 110 or may be communicated to the UE 110 by the NW, etc. In some embodiments, the UE 110 preference may be based on a quality measurement of a DL CC being above a predefined threshold for a predefined period of time. For example, the RSRP being above a predefined threshold for a period of time may indicate the UE 110 is relatively stationary and the channels are unlikely to change over time and therefore the CCs may have a preference for UL CA. There may be other non-quality measurement preference conditions that may be used to select preferred CCs for UL CA. Examples of these other non-quality measurement preference conditions will be described below.

The UE may then report this information to the NW periodically (at 310), when a predetermined event occurs (at 315), and/or when a trigger occurs the UE 110 to send this information (at 320). For example, a predetermined event may be a if a measured parameter (e.g., RSRP) is greater or less than some threshold for a certain period of time, a motion state of the UE 110 has changed, the thermal limitations of the UE 110 have changed, etc. A trigger may be the network (e.g., 5G NR-RAN 120) triggering the UE 110 to report by sending, for example, triggering DCIs on the PDCCH. These are only examples of events and/or triggers and those skilled in the art will understand the full range of events/triggers that may be used to cause the UE 110 to report the information to the 5G NR-RAN 120. Finally, at 325, the 5G NR-RAN 120 configures UL CA for the UE 110 taking into consideration, for example, the feedback from the UE 110 (e.g., the quality report(s) and/or UE preference), other 5G NR-RAN 120 conditions (e.g., congestion, etc.).

FIG. 4 shows a method 400 for providing UE feedback to a NW regarding UL CA according to the exemplary embodiments. The method 400 provides for communications from the UE 110 to provide feedback to the NW regarding CA combinations. As discussed above, feedback regarding CA combinations may be in response to a measurement configuration request from the NW. Thus, the method 400 is performed by the UE 110 and will be described with regard to the system 100 of FIG. 1. In the example of FIG. 4, the NW may be considered the 5G NR-RAN 120.

At 405, the UE 110 receives a measurement configuration request via radio resource control (RRC) signaling from the 5G NR-RAN 120. It may be considered that the UE 110 is already configured with DL CA and one or more CC activated on the UL side. In response, at 410, the UE 110 measures a quality of multiple CCs that may be used for UL CA combinations. In addition to or alternatively to this measurement, at 415, the UE 110 determines a UE preference regarding the multiple UL CA combinations based on at least one predetermined factor. Some exemplary preference factors were discussed above, and additional exemplary preference factors will be described below.

At 420, the UE 110 generates a message that includes the quality of the multiple UL CA combinations and/or the UE preferences. At 425, the UE 110 transmits the message to the 5G NR-RAN 120. In some embodiments, the message (i.e., the feedback) may be through RRC signaling, medium access control-control element (MAC-CE) signaling or a long Physical Uplink Control Channel (PUCCH) message. In some exemplary embodiments, the message may include, for example, physical layer measurements, UL CA combination preference, and UE limitations.

The feedback provided by the UE 110 to the 5G NR-RAN 120 may include a number (N) of UL CA combinations in terms of priority, where N may be in the measurement configuration request or a predetermined number. In some embodiments, the N UL CA combinations may be based on existing DL CA combinations available for the UE 110. Furthermore, if the UE 110 is already configured with UL CA, the reported N UL CA combinations do not need to include the existing UL SCCs since it is possible that those UL SCCs are not preferred CCs. There may be various manners of selecting the N UL CA combinations. The above described measurement based preferences. The following will describe other types of preferences to prioritize UL CA combinations to select the N UL CA combinations.

In addition to the exemplary factors described above (e.g., the quality measurement based factors), the UE 110 preference for different UL CA combinations may also be based on other one or more other types of factors. In some exemplary embodiments, these factors may include throughput priority (e.g., maximization of throughput), power efficiency priority (e.g., the amount of power needed to transmit each bit), beamforming priority, etc. These preference factors may be in addition to the factors described above or exclusive of the above factors. In some exemplary embodiments, the factors may be agreed upon between the UE and infrastructure vendors.

In addition to the above information, it was described above that UE 110 limitations may also be reported to the 5G NR-RAN 120 with the other UL CA information. For example, for each UL CA combination reported to the 5G NR-RAN 120, a bit mask corresponding to characteristics of the combination may be provided in addition to the physical layer metrics. These characteristics may include pre-agreed upon items such as, for example, intermodulation impact characteristics, thermal impact characteristics, power impact characteristics, transmission antenna conflict characteristics, beamforming conflict characteristics of each combination, etc.

The 5G NR-RAN 120 may then use some or all of this information received from the UE 110 regarding UL CA to determine the specific UL CA combinations to assign to the UE 110. Those skilled in the art will understand that the 5G NR-RAN 120 may also use other information in addition to the UE 110 feedback to assign UL CA combinations to the UE 110.

Moreover, since the measurements and/or characteristics can change over time, periodic or event-based reports may be sent by the UE 110 to the 5G NR-RAN 120 during UL CA operation. If the updated reports warrant a change to the assigned UL CA combinations, the 5G NR-RAN 120 may change the reports. In some exemplary embodiments, the periodicity of the reports may be increased 120 after UL CA has been activated.

In theory, the throughput of any UL CA combination is limited by the total channel capacity, which can be expressed as

$$C = {\sum }_{i} {W}_{i} {log}_{2} ( 1 + \frac{{P}_{i}^{T} \cdot {PL}_{i}}{{N}_{0} \cdot {W}_{i}} ) \approx {\sum }_{i} {W}_{i} {log}_{2} ( \frac{{P}_{i}^{T} \cdot {PL}_{i}}{{N}_{0} \cdot {W}_{i}} )$$

where Wᵢ is the bandwidth of the i^{th} CC, Pᵢ^{t} is the transmission power of the i^{th} CC, and PLᵢ is the pathloss of the i^{th} CC. The UE 110 may report physical layer metrics such as, for example, the reference signal received power (RSRP) of a selected active beam of each CC separately to the 5G NR-RAN 120 so that the 5G NR-RAN 120 can calculate the pathloss of each CC. The UE 110 may also report the total transmission power (Σᵢ Pᵢ^{t}). Based on this UE-reported information, the 5G NR-RAN 120 may calculate the transmission power for the UE 110 on each UL CC based on the activated BWP.

In addition, the 5G NR-RAN 120 may request, in the measurement configuration request, that these physical layer metrics be reported by the UE 110 regardless of whether or not the existing UL CA is active. The UE 110 may also adopt the same calculation for preference/priority when the limitations are the same for two UL CA combinations. The bandwidth of the new UL CC may be based the widest bandwidth part (BWP) configured on the DL.

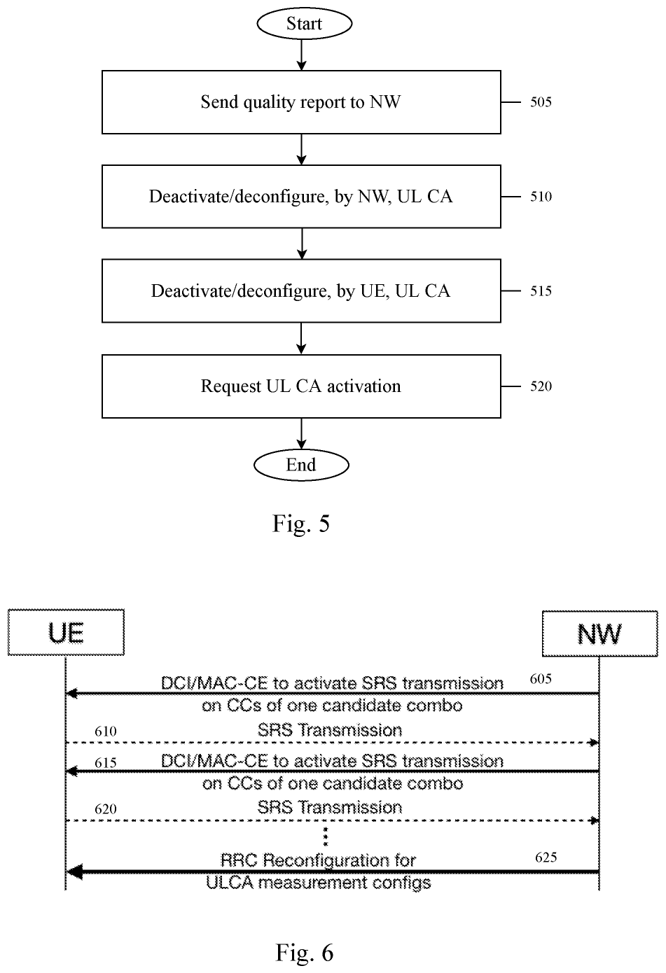

FIG. 5 shows a method of deactivating an uplink carrier aggregation by the UE 110 according to various exemplary embodiments. Because the UE 110 is more aware of UL data traffic based on the activity of applications at the UE 110, the UE 110 may be better suited to trigger UL CA deactivation/deconfiguration.

At 505, the UE 110 sends a quality report to the 5G NR-RAN 120 in which only the PCC is the single CC for the UL CA combination to indicate the limitations of the UE 110. This quality report is a suggestion by the UE 110 that the UL CA be deactivated. In some exemplary embodiments, the UE 110 may send a quality report to the NW 130 in which thermal/power limitations of the UE 110 are set to true for all UL CA combinations, e.g., the thermal or power limitations of the UE 110 as a result of the CA combination is not acceptable. In addition to the reports described above, in some exemplary embodiments the feedback may be reported to the 5G NR-RAN 120 via a MAC-CE, a UCI or PUCCH messages.

At 510, the 5G NR-RAN 120 may deactivate/deconfigure the UL CA based on the information that is received from the UE 110. However, since the 5G NR-RAN 120 is the entity that ultimately controls the activation/deactivation of CA, it is in the discretion of the 5G NR-RAN 120 whether or not to honor the request of the UE 110.

If, at 510, the NW 130 does not deactivate/deconfigure the UL CA, the UE 110 may unilaterally deactivate the UL CA at 515. However, because of the quality report sent by the UE 110 at 505, confusion at the 5G NR-RAN 120 is eliminated because the 5G NR-RAN 120 understands from the report that the UE 110 does not wish to continue with UL CA.

At 520, the UE 110 may request that a UL CA combination be activated due to upcoming high data traffic. For example, the UE may send feedback information to the 5G NR-RAN 120 that the uplink will experience high data traffic in the near future. This indication may be a separate indication within the reporting from the UE 110 to the 5G NR-RAN 120. The UE 110 may understand that such a high UL traffic scenarios may be upcoming based on applications running at the UE 110. In other exemplary embodiments, the UE 110 may report very favorable UL CA data in anticipation of the upcoming high data traffic condition that may cause the 5G NR-RAN 120 to activate UL CA.

FIG. 6 shows a signaling diagram that relates to sounding reference signal (SRS) UL CA activation according to various exemplary embodiments. SRSs are signals that may be inserted into the UL CC by the UE 110 at specific time, frequency and power level such that the 5G NR-RAN 120 (e.g., gNB 120A) may receive the SRSs and understand the channel characteristics of the CC. Thus, using the SRSs allows the gNB 120A to directly measure the quality of the UL CCs.

At 605, the 5G NR-RAN 120 may instruct the UE 110, for example, via a MAC-CE or a downlink channel information (DCI) message, to transmit SRSs on CCs of a first UL CA combination. This request may be made even before the CCs are added to the UL CA combinations for the UE 110. Cross carrier scheduling may be adopted for SRS transmissions even though targeted CCs are not yet added to the UL CA combinations.

At 610, the UE 110 transmits the SRSs on the CCs of the first UL CA combination. The PCC SRS may be scheduled at the same time as the SRS on these CCs to reflect any potential effects on beamforming and/or transmission (Tx) antenna conflicts. The transmission power of the SRS on the CCs may be equally divided among the CCs based on the maximum total transmission power.

At 615, the 5G NR-RAN 120 may instruct the UE 110 to transmit SRSs on CCs of a second UL CA combination even before those CCs are added to the UL CA combination for the UE 110. Cross carrier scheduling may also be adopted for these SRS transmissions even though the targeted CCs are not added to the UL CA combination yet.

At 620, the UE transmits the SRS on the CCs of the second UL CA combination. The PCC SRS may also be scheduled at the same time as the SRS on these CCs and the transmission power of the SRS on the CCs may again be equally divided among those CCs based on the maximum total transmission power.

Using this approach, the 5G NR-RAN 120 may obtain a better understanding of the UL condition because the quality of the UL CCs is directly measured. In some embodiments, multiple rounds of SRS transmissions may be used. In some embodiments, the UE 110 may autonomously (e.g., unilaterally) disable the SRS transmission of some CCs if the UE 110 determines that the transmission cost is not affordable, e.g., the amount of power needed to transmit the SRSs is detrimental to the battery life of the UE 110. After the UE SRS transmission(s), at 625, the 5G NR-RAN 120 may prioritize the UL CA combinations based on, for example, cell load, traffic pattern, radio frequency (RF) conditions, etc. As noted above, multiple rounds of SRS transmissions may be sent before the 5G NR-RAN 120 selects a UL CA combination at 625.

The exemplary embodiments describe various mechanisms related to advertising band combinations. These mechanisms may be used in conjunction with currently implemented band combination advertising methods, future implementations of band combination advertising methods or independently from other band combination advertising methods. The exemplary embodiments may apply to any scenario where the UE 110 is configured to advertise a plurality of band combinations to the network.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. In a further example, the exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. A method, comprising:
at a user equipment (UE):
receiving a measurement configuration request from a network;
in response to the measurement configuration request, measuring a quality of one or more uplink (UL) carrier aggregation (CA) combinations, wherein each UL CA combination comprises a plurality of component carriers;
generating a message that includes the quality of the one or more UL CA combinations; and
transmitting the message to the network.

2. The method of claim 1, further comprising:
determining a UE preference regarding the one or more UL CA combinations based on a predetermined factor, wherein the message further includes the UE preference.

3. The method of claim 2, wherein the predetermined factor comprises one of (a) a quality measurement of a downlink (DL) component carrier (CC) is greater than a predetermined value, or (b) the quality measurement of the DL CC is greater than the predetermined value for a predetermined period of time.

4. The method of claim 2, wherein the predetermined factor comprises one of a throughput priority, a power efficiency priority or a beamforming priority.

5. The method of claim 2, wherein a number N of UL CA combinations are included in the message, wherein when a number of UL CA combinations measured are greater than the number N, the number N of UL CA combinations selected for the message is based on the UE preference.

6. The method of claim 1, wherein the message further comprises a UE limitation corresponding to the one or more UL CA combinations, wherein the UE limitation comprises one of an intermodulation impact characteristic, a thermal impact characteristic, a power impact characteristic, a transmission antenna conflict characteristic, or a beamforming conflict characteristic.

7. The method of claim 1, wherein the message is transmitted to the network one of periodically, when a predetermined event occurs or when a trigger.

8. The method of claim 1, wherein the quality comprises a reference signal received power (RSRP) of a selected active beam of each component carrier.

9. A method, comprising:
at a user equipment (UE) with uplink (UL) carrier aggregation (CA) activated, the UL CA comprising a UL CA combination comprising primary component carrier (PCC) and a secondary component carrier (SCC);
determining that the UL CA should be deactivated; and
transmitting a quality report to a network comprising quality measurements for only the PCC.

10. The method of claim 9, further comprising:
transmitting, for the currently active UL CA, a report to the network indicating one of a thermal limitation or a power limitation of the UE are set to true for the active UL CA combination.

11. The method of claim 9, wherein the quality report is transmitted via one of a radio resource control (RRC) message, a Medium Access Control-Control Element (MAC-CE) or in an Uplink Control Information (UCI) format having a long Physical Uplink Control Channel (PUCCH).

12. A method, comprising:
at a network component:
instructing a UE to send transmit first sounding reference signals (SRS) on component carriers (CC) of a first UL CA combination;
receiving the first SRSs on the CCs of the first UL CA combination; and
determining quality characteristics of the first UL CA combination based on the first SRSs.

13. The method of claim 12, wherein the receiving and determining are performed for multiple samples of the SRSs.

14. The method of claim 12, further comprising:
instructing a UE to transmit second SRSs on CCs of a second UL CA combination;
receiving the second SRSs on the CCs of the second UL CA combination; and
determining quality characteristics of the second UL CA combination based on the SRS.

15. The method of claim 14, further comprising:
activating one of the first or second UL CA combinations based on at least the determined quality characteristics.

16. The method of claim 15, wherein activating the one of the first or second UL CA combination is further based on one or more predetermined criteria.

17. The method of claim 16, wherein the one or more predetermined criteria comprises cell load, traffic pattern, and radio frequency (RF) conditions.

18. The method of claim 12, wherein the instructing the UE to transmit is based on one of a medium access control-control element (MAC-CE) or a downlink control information (DCI) message.

19. The method of claim 12, wherein SRSs for a primary component carrier (PCC) of the first UL CA combination is scheduled at the same time as the SRSs for a secondary component carrier (SCC) of the first UL CA combination.

20. The method of claim 12, wherein a transmission power of the SRSs is divided equally among the CCs based on a maximum total transmission power.
